(19) United States
(12) Patent Application Publication
(10) Pub. No.: US 2008/0298062 A1
(43) Pub. Date: Dec. 4, 2008

(54) LED ILLUMINATION DEVICE

(76) Inventor: Pei-Choa WANG, Gueishan Township (TW)

Correspondence Address: HDSL, P.O. BOX 220746, CHANTILLY, VA, 20153-0746, US

(21) Appl. No.: 12/033,248

(22) Filed: Feb. 19, 2008

(30) Foreign Application Priority Data
May 30, 2007 (TW) 096208854

(51) Int. Cl. F21V 7/00

(52) U.S. Cl. 362/247

(57) ABSTRACT

An LED illumination device includes a die casting lamp cover, a plurality of LED modules, a reflection cover, and a transparent module. A top surface of the die casting lamp cover protrudes forth to form a plurality of heat dissipating fins, and the LED modules are assembled in an accommodating room of the die casting lamp cover. The LED modules respectively include a LED lamp assembly and an isothermal vapor chamber. The reflection cover includes a plurality of openings surroundingly arranged on outside of the LED modules correspondingly. The transparent module are arranged under the die casting lamp cover and enclosed in the accommodating room. The LED illumination device can uniformly disperse light beams from the LED modules to outside for reducing energy loss, and further can efficiently dissipate heat to reduce chances of damaging the LEDs because of high temperature.

### FIELD OF THE INVENTION

The present invention relates to an illumination device, and more specifically, to a light emitting diode (LED) illumination device used in outdoor or indoor places.

### DESCRIPTION OF THE RELATED ART

Generally, LEDs have advantages of a fine brightness, a long using life, saving energy, and so on. Therefore, many manufacturers have already applied LEDs into various products, such as, outdoor or indoor illumination devices, and so on. Even more, some manufacturers have applied LEDs into laptop computers to replace conventional cathode ray tubes in screens of the laptop computers.

Taiwan patent No. M307091 discloses an illumination device including an aluminum extrusion lamp cover, a plurality of LED modules, an end cover assembly, and a transparent mask. The aluminum extrusion lamp cover has a base, a plurality of heat dissipating fins extending from a top surface of the base, and a carrying portion formed on an inside surface of the base. Every two adjacent heat dissipating fins form a heat dissipating pass therebetween. The plurality of LED modules include a fixing base, a lamp cover fixed on one side of the fixing base, and a plurality of LEDs accommodated in the lamp cover. The fixing base has a connection portion corresponding to the carrying portion of the base for fixing interconnection. The end covers are separately enclosed and connected to front and back sides of the aluminum extrusion lamp cover. The transparent mask is arranged under the aluminum extrusion lamp cover, and an accommodating room is arranged among the aluminum extrusion lamp cover, the end covers and the transparent mask for receiving the LED modules.

However, the above conventional illumination device can't sufficiently disperse light beams of the LEDs to outside, and the structure of the conventional illumination device is complex. The conventional illumination device has some disadvantages on assembly and maintenance, and therefore, the conventional illumination device is needed to be improved.

### BRIEF SUMMARY

A light emitting diode (LED) illumination device includes a die casting lamp cover, a plurality of LED modules, a reflection cover, and a transparent module. The die casting lamp cover is formed an accommodating room. The die casting lamp cover includes an inner surface and a top surface, and a plurality of heat dissipating fins are protruded out from the top surface 13. The plurality of LED modules are assembled in the accommodating room and attached on the inner surface of the die casting lamp cover. Each LED module includes a LED lamp assembly and an isothermal vapor chamber disposed between the LED lamp assembly and the inner surface of the die casting lamp cover. The reflection cover includes a plurality of openings arranged on outside of the LED modules correspondingly, and a coating reflection surface arranged corresponding to the illuminating direction of the LED modules. The transparent module is arranged under the die casting lamp cover and enclosed in the accommodating room.

Because of using the reflection cover, the LED illumination device can uniformly disperse light beams from the LED modules to outside for reducing energy loss. Further, the isothermal vapor chamber can efficiently dissipate heat to reduce chances of damaging the LEDs because of too hot.

In addition, the die casting lamp cover is in one-piece, so that the number of elements of the LED illumination device is reduced. Therefore, the structure of the LED illumination device is simple and facilitates to assemble and maintain.

The transparent module includes a transparent cover having an inner surface, and the inner surface of the transparent cover is wavy. Because of the inner surface of the transparent cover, the transparent cover can uniformly transmit light beams. On the other hand, depending on changing the wavy, the transparent cover can focus light beams on a position.

The accommodating room may include a first room and a second room adjacent to the first room, wherein the LED modules are assembled in the first room, and the second room can receive other elements, such as a transformer, and so on. The first room and the second room can separate higher temperature and lower temperature to reduce chances of damaging the LEDs because of high temperature.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of an LED illumination device of a preferred embodiment of the present invention;

FIG. 2 is a schematic, sectional view of the LED illumination device in FIG. 1;

FIG. 3 is another schematic, sectional view of the LED illumination device in FIG. 1;

FIG. 4 is a schematic, exploded view of the lamp cover and the transparent module of the LED illumination device in FIG. 1;

FIG. 5 is a schematic, exploded view of the lamp cover and the LED modules of the LED illumination device in FIG. 1; and

FIG. 6 is a schematic, exploded view of the transparent module of the LED illumination device in FIG. 1.

### DETAILED DESCRIPTION

Reference will now be made to the drawings to describe a preferred embodiment of the present in-mould molding touch module, in detail.

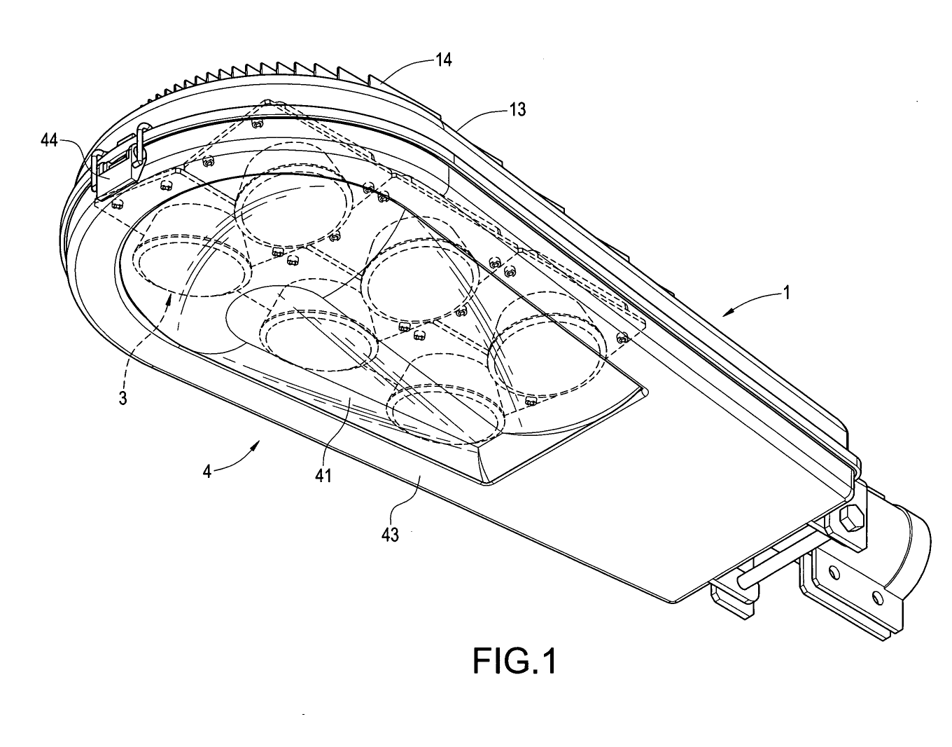

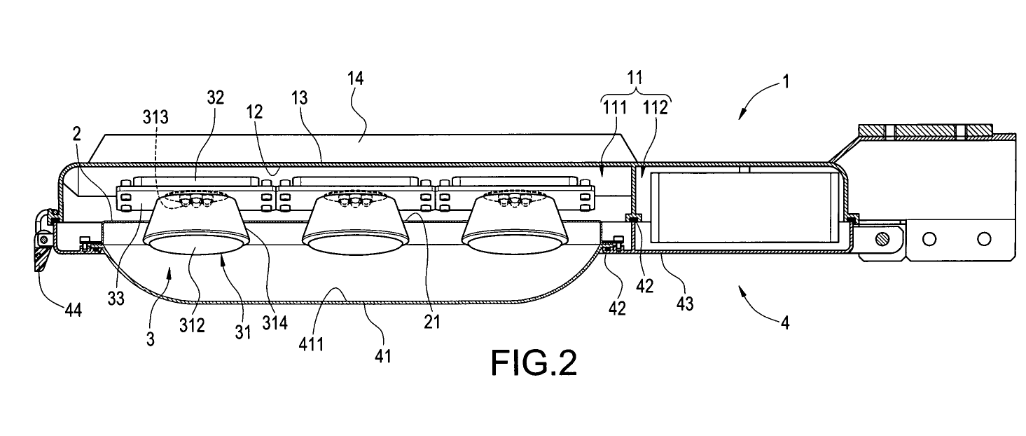

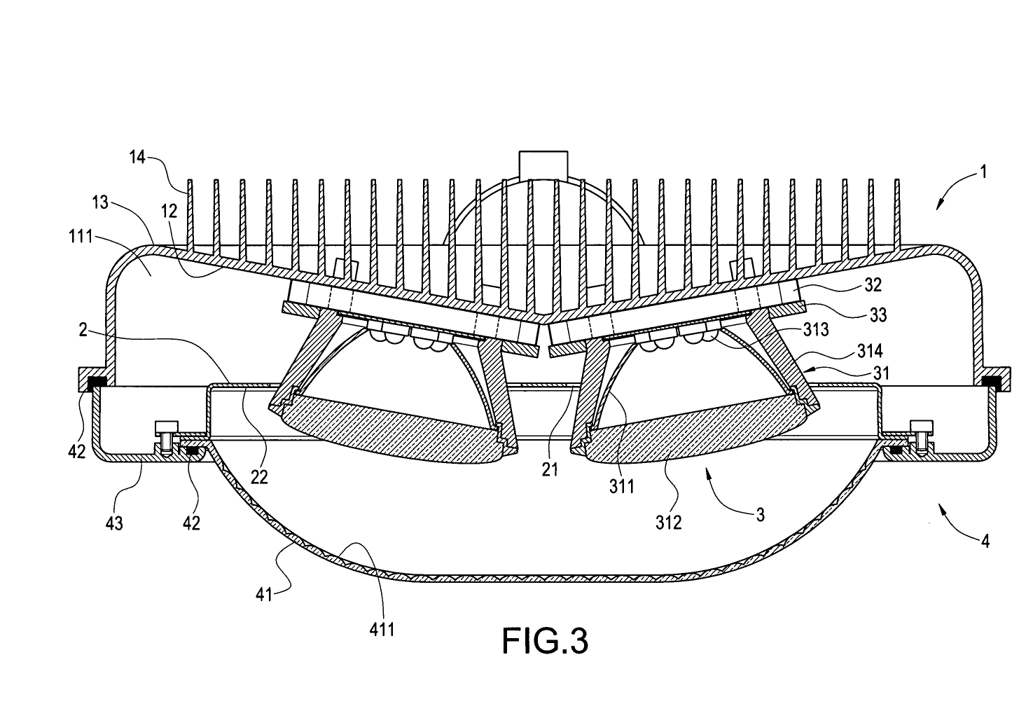

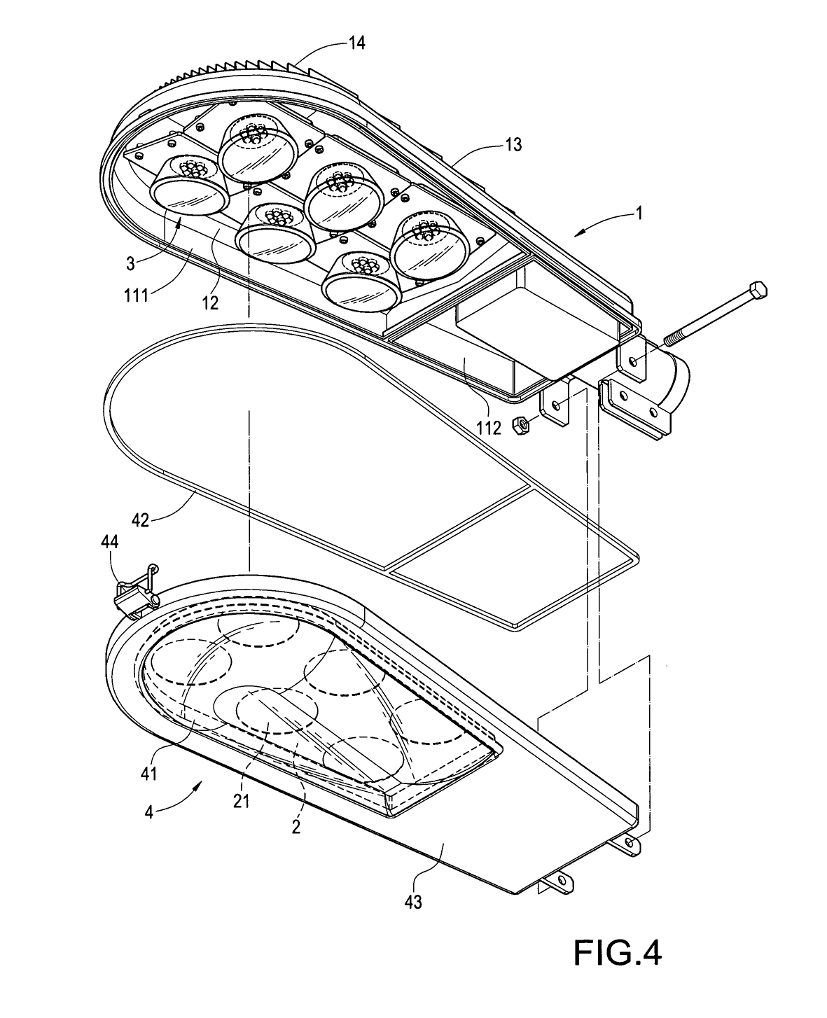

Referring to FIGS. 1 to 4, the LED illumination device includes a die casting lamp cover 1, a plurality of LED modules 3, a reflection cover 2, and a transparent module 4. The die casting lamp cover is formed an accommodating room 11. The die casting lamp cover 1 includes an inner surface 12 and a top surface 13, and a plurality of heat dissipating fins 14 are protruded out from the top surface 13. In this embodiment, the accommodating room 11 includes a first room 111 and a second room adjacent 112 to the first room 111.

The plurality of LED modules 3 are assembled in the first room 111 of the accommodating room 11 and attached on the inner surface 12 of the die casting lamp cover 1. Each LED module 3 includes a LED lamp assembly 31 and an isothermal vapor chamber 32, and the isothermal vapor chamber 32 is disposed between the LED lamp assembly 31 and the inner surface 12 of the die casting lamp cover 1.

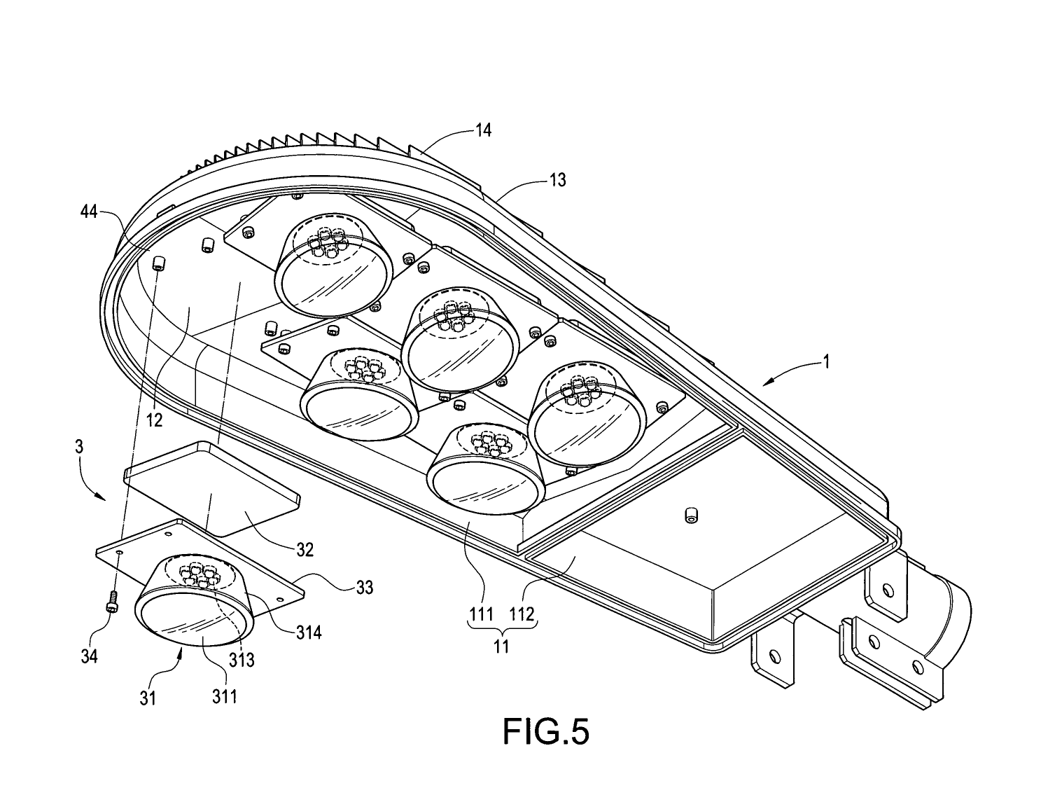

Referring to FIG. 5, in this embodiment, the LED module 3 further include a fixing plate 33 for fixing the LED lamp assembly 31 thereon, and the isothermal vapor chamber 32 is disposed among the LED lamp assembly 31, the fixing plate 33 and the inner surface 12 of the die casting lamp cover 1. The LED modules 3 are secured on the inner surface 12 of the die casting lamp cover 1, as shown in FIG. 5, and a plurality of bolts 34 passing through the fixing plate 33 to fix on the inner surface 12 of the die casting lamp cover 1.

The LED lamp assembly 31 comprises a lamp cup 311, a lens 312, a plurality of LEDs 313, and a cover 314. In this embodiment, every LED lamp assembly 31 includes six LEDs 313. The lens 312 is arranged on the bottom end of the lamp cup 311, and the LEDs 313 are arranged on the top end of the lamp cup 311. The cover 314 has an end connected to the fixing plate 33 and extending downward to envelop on outside of the lamp cup 311 and the lens 312.

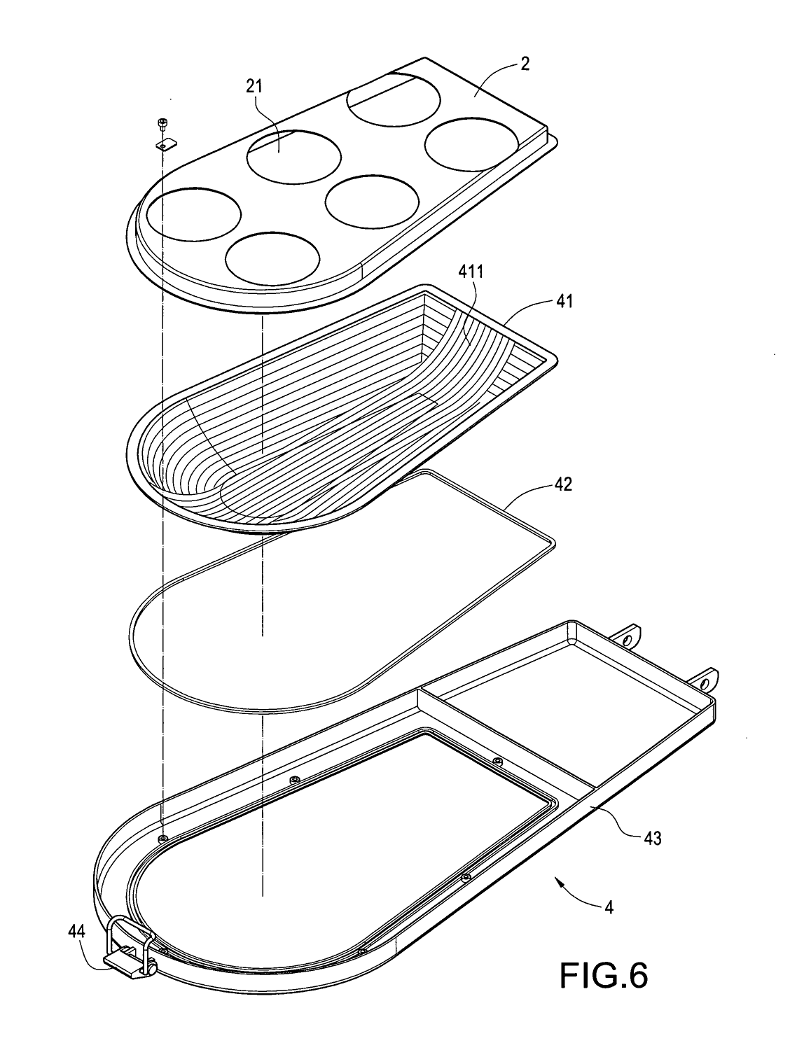

Referring to FIG. 6, the reflection cover 2 includes a plurality of openings 21 and a coating reflection surface 22. The number of the openings 21 of the reflection cover 2 is the same as the number of the LED modules 3. The openings 31 are arranged on outside of the LED modules 3 correspondingly, and the openings 31 are adjacent to the inner surface 12 of the die casting lamp cover 1. The coating reflection surface 22 is arranged corresponding to the illuminating direction of the LED modules 3.

The transparent module 4 is assembled on the die casting lamp cover 1 and enclosed in the first room 11. In this embodiment, the transparent module 4 includes a transparent cover 41, two adhesive pieces 42 and a foot cover 43. The transparent cover 41 is a transparent body, and has an inner surface 411. One adhesive piece 42 is arranged between the transparent cover 41 and the foot cover 43, and another adhesive piece 42 is arranged between the foot cover 43 and the die casting lamp cover 1, whereby the transparent module 4 can have functions of waterproof and dustproof. A lock ring 44 is arranged at the center of the outside of the foot cover 43, and the transparent module 4 and the die casting lamp cover 1 are interconnected by the lock ring 44. The reflection cover 2 is connected to the transparent cover 4 by a pressure plate and bolts.

The reflection cover 2 can uniformly disperse light beams from the LED modules 3 to outside for reduce optical energy loss. Furthermore, the isothermal vapor chamber 32 can efficiently dissipate heat to reduce chances of damaging the LEDs because of higher temperature.

In addition, the die casting lamp cover 1 is one-piece, and the number of elements of the LED illumination device is reduced. Therefore, the structure of the LED illumination device is simple and facilitates to assemble and repair.

The inner surface 411 of the transparent cover 41 is wavy, and therefore, when light beams from the LEDs 313 pass through the inner surface 411, the inner surface 411 of the transparent cover 41 can more uniformly transmit the light beams. On the other hand, depending on changing sizes or angles of the wavy, the transparent cover 41 can focus light beams from the LEDs 313 on a position.

In addition, the LED modules 3 are assembled in the first room 111, and the second room 112 can receive other elements, such as a transformer, and so on. The first room 111 and the second room 112 can separate high temperature and lower temperature to reduce chances of damaging the LEDs 313 because of high temperature.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A light emitting diode (LED) illumination device, comprising:
a die casting lamp cover, having an accommodating room, the die casting lamp cover comprising an inner surface and a top surface, and a plurality of heat dissipating fins being protruded from the top surface;
a plurality of LED modules, disposed in the accommodating room and attached on the inner surface of the die casting lamp cover, each LED module comprising a LED lamp assembly and a dissipateisothermal vapor chamber disposed between the LED lamp assembly and the inner surface of the die casting lamp cover;
a reflection cover, comprising a plurality of openings arranged on outside of the LED modules correspondingly, and a coating reflection surface arranged corresponding to an illuminating direction of the LED modules; and
a transparent module, arranged under the die casting lamp cover and enclosed in the accommodating room.

2. The LED illumination device as claimed in claim 1, wherein the number of the openings of the reflection cover is the same as the number of the LED modules.

3. The LED illumination device as claimed in claim 1, wherein the LED modules further comprise a fixing plate for fixing the LED lamp assembly thereon, and the isothermal vapor chamber is disposed among the LED lamp assembly, the fixing plate and the inner surface of the die casting lamp cover.

4. The LED illumination device as claimed in claim 1, wherein the LED lamp assembly comprises a lamp cup, a lens arranged on the bottom end of the lamp cup, and at least one LED arranged on the top end of the lamp cup.

5. The LED illumination device as claimed in claim 1, wherein the transparent module comprises a transparent cover having an inner surface, and the inner surface of the transparent cover is wavy.

6. The LED illumination device as claimed in claim 5, wherein the transparent module further comprises an adhesive piece disposed between the transparent cover and the die casting lamp cover.

7. The LED illumination device as claimed in claim 5, wherein the transparent module further comprises an adhesive piece and a foot cover, wherein the adhesive piece is disposed between the transparent cover and the foot cover.

8. The LED illumination device as claimed in claim 7, further comprising a lock ring arranged at the center of the outside of the foot cover for locking the transparent module and the die casting lamp cover.

9. The LED illumination device as claimed in claim 1, wherein the accommodating room comprises a first room and a second room adjacent to the first room, wherein the LED modules are assembled in the first room.

10. The LED illumination device as claimed in claim 1, wherein the LED modules are secured on the inner surface of the die casting lamp cover.
